(19) United States
(12) Patent Application Publication
(10) Pub. No.: US 2005/0074240 A1
(43) Pub. Date: Apr. 7, 2005

(54) Wavelength-division-multiplexed passive optical network system using wavelength-seeded light source

(76) Inventors: Dae-Kwang Jung, Suwon-si (KR); Yun-Je Oh, Yongin-si (KR); Seong-Taek Hwang, Pyeongtaek-si (KR)

Correspondence Address: CHA & REITER, LLC, 210 ROUTE 4 EAST STE 103, PARAMUS, NJ, 07652, US

(21) Appl. No.: 10/778,426

(22) Filed: Feb. 13, 2004

(30) Foreign Application Priority Data
Oct. 1, 2003 (KR) 2003-68317

(51) Int. Cl. H04J 14/00

(52) U.S. Cl. 398/72

(57) ABSTRACT

An economical wavelength-division-multiplexed passive optical network (WDM-PON) system is realized by directly modulating a wavelength-seeded light source to transmit upstream or downstream data, without using an expensive external modulator. A multiplexed signal having the same wavelength as the waveguide grating is generated and used to control the temperature of the waveguide grating and adjust the wavelength of a wavelength-division-multiplexed signal routed to a transfer link. The wavelength selectivity and stabilization of each light source are not required. Since upstream and downstream signals can be multiplexed and demultiplexed concurrently by each waveguide grating located in the central office and the remote node, it is possible to reduce the number of waveguide gratings used in a WDM optical network. In addition, upstream and downstream signals can be transmitted concurrently using a single-strand transfer optical fiber, thereby realizing an economical and efficient WDM-PON.

### CLAIM OF PRIORITY

This application claims priority to an application entitled “Wavelength-Division-Multiplexed Passive Optical Network System Using Wavelength-Seeded Light Source,” filed in the Korean Intellectual Property Office on Oct. 1, 2003 and assigned Serial No. 2003-68317, the contents of which are hereby incorporated by reference.

### BACKGROUND OF THE INVENTION

1. Field of the Invention

The present invention relates to a wavelength-division-multiplexed passive optical network (WDM-PON), and more particularly to a wavelength-division-multiplexed passive optical network system using a wavelength-seeded light source.

2. Description of the Related Art

Wavelength-division-multiplexed passive optical networks (WDM-PONs) provide high-speed broadband communication services using a unique wavelength assigned to each subscriber. Accordingly, WDM-PONs can protect the confidentiality of communications and easily accommodate various communication services and the large communication capacity required by the subscribers. As an additional benefit, increasing the number of subscribers is easily accomplished by adding respective unique wavelengths.

Despite such advantages, however, WDM-PONs have not yet been put to practical use. Both a central office (CO) and each subscriber unit of a WDM-PON require a light source of a particular oscillation wavelength and an additional wavelength stabilizing circuit for stabilizing the wavelength of the light source. Such light source and wavelength stabilizing circuit can be a great financial burden on the WDM-PON subscribers. Therefore, it is necessary to develop an economical WDM light source for the utilization of WDM-PONs.

Although a WDM-PON light source is generally implemented as a distributed feedback laser (DFB laser), a distributed feedback laser array (DFB laser array), a multi-frequency laser (MFL) or a picosecond pulse light source, such conventional WDM light sources have the following drawbacks.

A “distributed feedback laser array” and a “multi-frequency laser” are fabricated by complicated processes. They are expensive light sources that essentially require exact wavelength selectivity and wavelength stabilization for the wavelength-division-multiplexing. Therefore, neither the distributed feedback laser array nor the multi-frequency laser is suitable to establish economical WDM-PONs.

A “picosecond pulse light source” has a broad spectral bandwidth and coherence. However, this light source has low spectrum stability and a narrow pulse width represented by tens of picoseconds.

Recent studies about more economical WDM light sources have suggested a spectrum-sliced light source, a mode-locked Fabry Perot laser with incoherent light and a wavelength-seeded reflective semiconductor optical amplifier, which do not require wavelength selectivity or stabilization, and which enable easy wavelength control.

A “spectrum-sliced light source” can provide a large number of wavelength-divided high output channels by spectrally slicing amplified spontaneous emission (ASE) light generated by an optical fiber amplifier, instead of a conventional light source. However, an expensive external modulator, such as a LiNbO₃ modulator, is additionally required for channels to transmit different data. The spectrum-sliced light source is therefore not suitable for establishing economical WDM-PONs.

Wavelength-seeded light sources, such as a “mode-locked Fabry-Perot laser with incoherent light” and a “wavelength-seeded reflective semiconductor optical amplifier,” receive an optical signal and output an optical signal of the same wavelength which has been directly modulated according to the data to be transmitted. Such wavelength-seeded light sources have been suggested as economical and high performance light sources and actively researched.

In particular, when a spectrum-sliced incoherent optical signal which has been generated by a spectrum-sliced light source is injected into a Fabry-Perot laser, the Fabry-Perot laser outputs an optical signal locked in the wavelength of the injected signal and is concurrently directly modulated according to a data signal for more economical data transmission.

Similarly, when a spectrum-sliced incoherent optical signal generated by a spectrum-sliced light source is injected into a reflective semiconductor optical amplifier, the injected optical signal is amplified and outputted again. The reflective semiconductor optical amplifier is, concurrent with its amplification function, directly modulated according to a data signal so that it can economically generate and transmit a high-output optical signal modulated at higher speed.

It is accordingly possible to establish economical WDM-PONs for transmitting upstream/downstream data using the above light sources.

### SUMMARY OF THE INVENTION

The present invention has been made to solve the above-mentioned problems occurring in the prior art, and an object of the present invention is to provide an economical wavelength-division-multiplexed passive optical network (WDM-PON) system using an economical and efficient wavelength-seeded light source.

In accordance with a first embodiment of the present invention for accomplishing the above object, there is provided a WDM-PON system including a central office and a remote node which is linked to the central office and a plurality of subscriber units through optical fibers, wherein said central office includes: a first broadband light source for supplying an optical signal to be injected into a downstream wavelength-seeded light source; a second broadband light source for supplying an optical signal to be injected into an upstream wavelength-seeded light source included in the plurality of subscriber units; a 2×2 optical splitter for combining broadband signals generated by the first and second broadband light sources with upstream and downstream optical signals, respectively; a 1×N mux/demux for spectrum-slicing a broadband signal generated by the first broadband light source and at the same time demultiplexing an upstream optical signal and/or multiplexing a downstream optical signal; a wavelength-seeded light source for receiving a spectrum-sliced optical signal and outputting a downstream optical signal having the same wavelength as the received optical signal and directly modulated according to downstream data to be transmitted; an optical receiver for detecting an upstream optical signal as an electric signal; and a wavelength-division-multiplexer for demultiplexing the upstream optical signal and the spectrum-sliced optical signal and multiplexing the downstream optical signal.

In accordance with a second embodiment of the present invention, there is provided a WDM-PON system including a central office and a remote node which is linked to the central office and a plurality of subscriber units through optical fibers, wherein said central office includes: a first broadband light source for supplying an optical signal to be injected into a downstream wavelength-seeded light source; a second broadband light source for supplying an optical signal to be injected into an upstream wavelength-seeded light source included in the plurality of subscriber units; an N×N mux/demux for spectrum-slicing a broadband signal generated by the first broadband light source and at the same time demultiplexing a multiplexed upstream optical signal from the remote node and/or multiplexing a downstream optical signal; a first optical circulator for inputting a broadband signal generated by the first broadband light source to the N×N mux/demux and a multiplexed downstream optical signal outputted from the N×N mux/demux to a transfer optical fiber; a second optical circulator for inputting a broadband signal generated by the second broadband light source to the transfer optical fiber and a multiplexed upstream optical signal transmitted to the N×N mux/demux for said demultiplexing; a wavelength-division-multiplexer for demultiplexing the multiplexed downstream optical signal inputted from the first optical circulator, the broadband signal inputted from the second optical circulator and said multiplexed upstream optical signal; a wavelength-seeded light source for receiving the spectrum-sliced optical signal and outputting a downstream optical signal having the same wavelength as the received optical signal and directly modulated according to downstream data to be transmitted; and an optical receiver for detecting an upstream optical signal as an electric signal.

In accordance with a third embodiment of the present invention, there is provided a WDM-PON system including a central office and a remote node which is linked to the central office and a plurality of subscriber units through optical fibers, wherein said central office includes: a broadband light source for simultaneously supplying optical signals to be injected into a downstream wavelength-seeded light source and an upstream wavelength-seeded light source; a fiber Bragg grating for passing a portion of broadband optical signals generated by the broadband light source, said portion having a wavelength of a downstream optical signal, while said grating reflects a portion having a wavelength of an upstream optical signal; an optical circulator for outputting the broadband signals generated by the broadband light source to the fiber Bragg grating, said multiplexed downstream optical signal to a transfer optical fiber and said multiplexed upstream optical signal to an N×N mux/demux; said N×N mux/demux for receiving and spectrum-slicing a broadband signal having the same wavelength as the downstream optical signal passing through the fiber Bragg grating and at the same time multiplexing a downstream optical signal and/or demultiplexing an upstream optical signal; a wavelength-seeded light source for receiving the spectrum-sliced optical signal and outputting the downstream optical signal to be multiplexed, said downstream optical signal to be multiplexed having the same wavelength as the received optical signal and being directly modulated according to downstream data to be transmitted; and an optical receiver for detecting an upstream optical signal as an electric signal.

In order to supply an optical signal to be injected into the upstream wavelength-seeded light source included to the plurality of subscriber units, the remote node should preferably include an 1×N mux/demux for spectrum-slicing a broadband signal generated and transmitted from the central office and at the same time demultiplexing a multiplexed downstream optical signal transmitted from the central office, while multiplexing an upstream optical signal transmitted from the subscriber units.

Also, each subscriber unit should preferably include a wavelength-division-multiplexer for multiplexing or demultiplexing an upstream or downstream optical signal and a spectrum-sliced optical signal transmitted from the remote node, an optical receiver for receiving a downstream optical signal and an upstream wavelength-seeded light source for receiving the spectrum-sliced optical signal and outputting an upstream optical signal having the same wavelength as the received optical signal and directly modulated according to upstream data to be transmitted.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram of a wavelength-division-multiplexed passive optical network (WDM-PON) system according to the first embodiment of the present invention.

FIG. 2a shows a spectrum of multiplexed upstream and downstream signals that are distinguished by being spaced with the free spectral range of a waveguide grating.

FIG. 2b shows a spectrum of signals multiplexed or demultiplexed by a wavelength-division-multiplexer provided in each of the central office and subscriber units of the WDM-PON system according to the first embodiment of the present invention.

FIG. 3 is a block diagram of a WDM-PON system according to the second embodiment of the present invention.

FIG. 4 is a block diagram of a WDM-PON system according to the third embodiment of the present invention.

FIGS. 5a and 5b show signal passing characteristics of a broadband Bragg grating provided in the WDM-PON system according to the third embodiment of the present invention.

### DETAILED DESCRIPTION OF THE PREFERRED EMBODIMENT

Hereinafter, preferred embodiments of the present invention will be described with reference to the accompanying drawings. In the following description of the present invention, detailed description of known functions and configurations incorporated herein will be omitted for clarity of presentation.

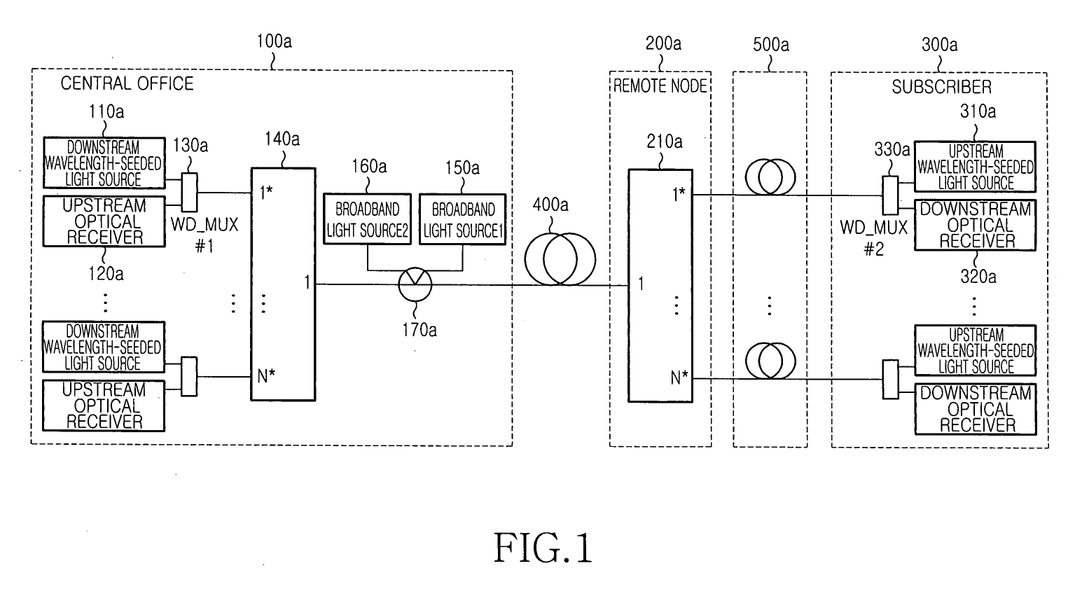

FIG. 1 shows, by way of illustrative and non-limitative example, a wavelength-division-multiplexed passive optical network (WDM-PON) system according to the first embodiment of the present invention. FIG. 1 illustrates a WDM-PON system using wavelength-seeded light sources as upstream and downstream light sources. In the WDM-PON system according to the first embodiment of the present invention, a central office 100a is linked to a remote node 200a through an optical fiber 400a. Also, the remote node 200a is linked to a plurality of subscriber units 300a through optical fibers 500a.

The central office 100a includes two broadband light sources (first broadband light source 150a and second broadband light source 160a) for outputting optical signals with different wavelengths, a 2×2 optical splitter 170a, a 1×N waveguide grating 140a for demultiplexing a multiplexed upstream signal and multiplexing downstream signals, a plurality of wavelength-division-multiplexers (WD_MUX #1) 130a for multiplexing and demultiplexing upstream and downstream signals having different wavelengths, and a downstream wavelength-seeded light source 110a and an upstream optical receiver (Rx) 120a for each mux 130a. The multiplexers 130a, the light sources 110a and the receivers 120a may be regarded as a single multiplexer, a single light source and a single receiver, although they will be referred to as separate entities in the discussion that follows.

The remote node (RN) 200a includes a 1×N waveguide grating 210a for demultiplexing a multiplexed downstream signal and multiplexing upstream signals.

Each of the subscriber units of the plurality 300a includes a downstream optical receiver 320a, an upstream wavelength-seeded light source 310a and a wavelength-division-multiplexer (WD_MUX #2) 330a for multiplexing and demultiplexing upstream and downstream signals with different wavelengths. The light sources 310a and optical receivers 320a may likewise be regarded as a single light source and a single optical receiver, although referred to below as separate entities.

Operationally, the first broadband light source 150a of the central office 100a generates and outputs a broadband signal that will be used to generate downstream flow. The broadband signal is routed through the 2×2 optical splitter 170a to the 1×N waveguide grating 140a and spectrally sliced. Channels spectrally sliced at the 1×N waveguide grating 140a are injected into each downstream wavelength-seeded light source 110a through the plurality of wavelength-division-multiplexers 130a. The downstream wavelength-seeded light sources 110a output optical signals having the same respective wavelengths as the channels injected through the wavelength-division-multiplexers 130a and directly modulated according to downstream data to be transmitted. Each downstream signal outputted from the downstream wavelength-seeded light source 110a is routed again to the 1×N waveguide grating 140a by means of the wavelength-division-multiplexers (WD_MUX #1) 130a and multiplexed at the grating 140a. The multiplexed downstream signals are transmitted through the 2×2 optical splitter 170a to the transfer optical fiber 400a and then transmitted to the remote node 200a.

The multiplexed downstream signals transmitted to the remote node 200a are inputted to and demultiplexed at the 1×N waveguide grating 210a. The demultiplexed downstream signals are transmitted to the plurality of subscriber units 300a through the transfer optical fibers 500a linked thereto.

The downstream signals transmitted to the plurality of subscriber units 300a through the transfer optical fibers 500a and inputted to the downstream optical receivers 320a by means of the respective wavelength-division-multiplexers (WD_MUX #2) 330a and detected as electric signals.

The second broadband light source 160a of the central office 100a generates and outputs a broadband signal that will be used to generate upstream flow. The broadband signal is routed through the 2×2 optical splitter 170a to the transfer optical fiber 400a and transmitted by means of the optical fiber to the 1×N waveguide grating 210a of the remote node 200a. The 1×N waveguide grating 210a spectrum slices the broadband signal and transmits, by means of the transfer optical fibers 500a, spectrum-sliced channels to the plurality of subscriber units 300a. The channels are there injected into the respective upstream wavelength-seeded light sources 310a after having passed through the wavelength-division-multiplexers (WD_MUX #2) 330a.

The respective upstream wavelength-seeded light source 310a output optical signals having the same respective wavelengths as the injected spectrum-sliced channels and directly modulated according to upstream data to be transmitted.

The upstream signals outputted from the upstream wavelength-seeded light sources 310a are transmitted to the remote node 500a after passing through the wavelength-division-multiplexers (WD_MUX #2) 330a. The upstream signals transmitted to the remote node 500a are inputted again to the 1×N waveguide grating 210a to be multiplexed. The multiplexed upstream signals are transmitted to the central office 100a after passing through the transfer optical fiber 400a. The multiplexed upstream signals transmitted to the central office 100a are routed through the 2×2 optical splitter 170a to the 1×N waveguide grating 140a and then demultiplexed. The upstream signals demultiplexed at the 1×N waveguide grating 140a are inputted to the respective upstream optical receivers 120a by means of the wavelength-division-multiplexers (WD_MUX #1) 130a and detected as electric signals.

The 1×N waveguide grating 140a and the 1×N waveguide grating 210a are each capable of simultaneously multiplexing and demultiplexing respectively directed signals, because the waveguide gratings have a periodic band pass characteristic based on a free-spectral range.

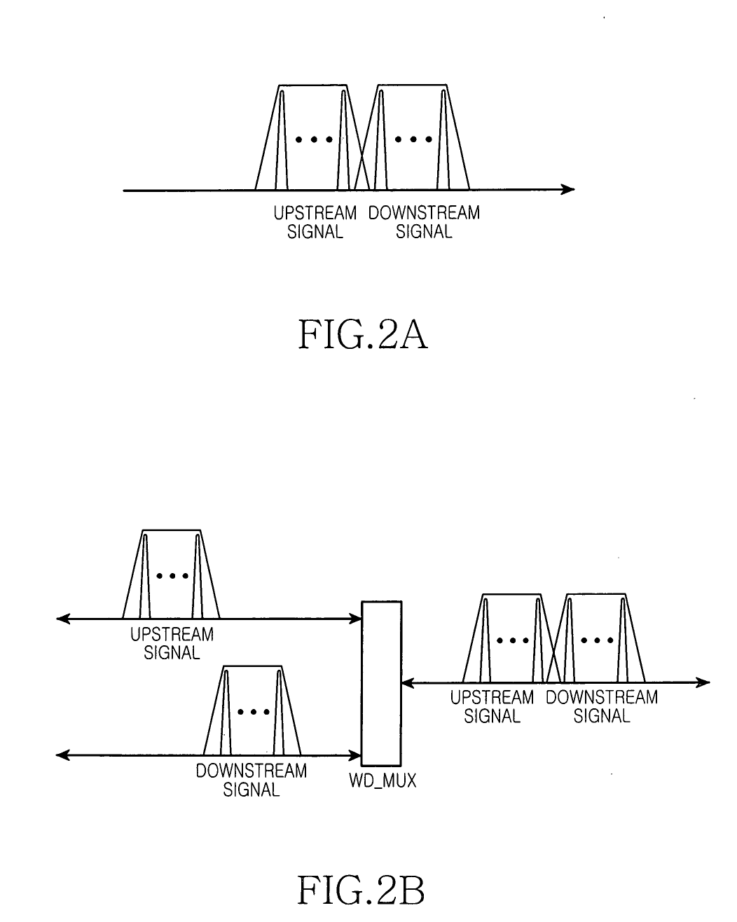

FIG. 2a conceptually shows a spectrum of multiplexed upstream and downstream signals which are distinguished by being spaced with the free-spectral range of a waveguide grating. As shown in FIG. 2a, upstream and downstream signals can have distinct wavelengths of 1,300 nm and 1,540 nm, 1,540 nm and 1,580 nm, or 1,300 nm and 1,580 mm.

FIG. 2b conceptually shows the spectral bandwidths of signals multiplexed and demultiplexed by a wavelength-division-multiplexer (WD_MUX) provided in each of the central office and subscriber units of the WDM-PON system according to the first embodiment of the present invention. In FIG. 2b, the left side of the wavelength-division-multiplexor (WD_MUX) shows a demultiplexed spectral bandwidth, while the right side shows a multiplexed spectral bandwidth.

The WDM-PON system having the structure as shown in FIG. 1 preferably uses a single module integrating the upstream optical receiver 120a, downstream wavelength-seeded light source 110a and wavelength-division-multiplexer (WD₁₃ MUX) 130a of the central office 100a. Accordingly, the scaled-down optical communication system located in the central office 100a can accommodate a larger number of subscribers, whereas an inability to integrate these elements into a single module would, due to the volumes of the separate module, prevent such an accommodation.

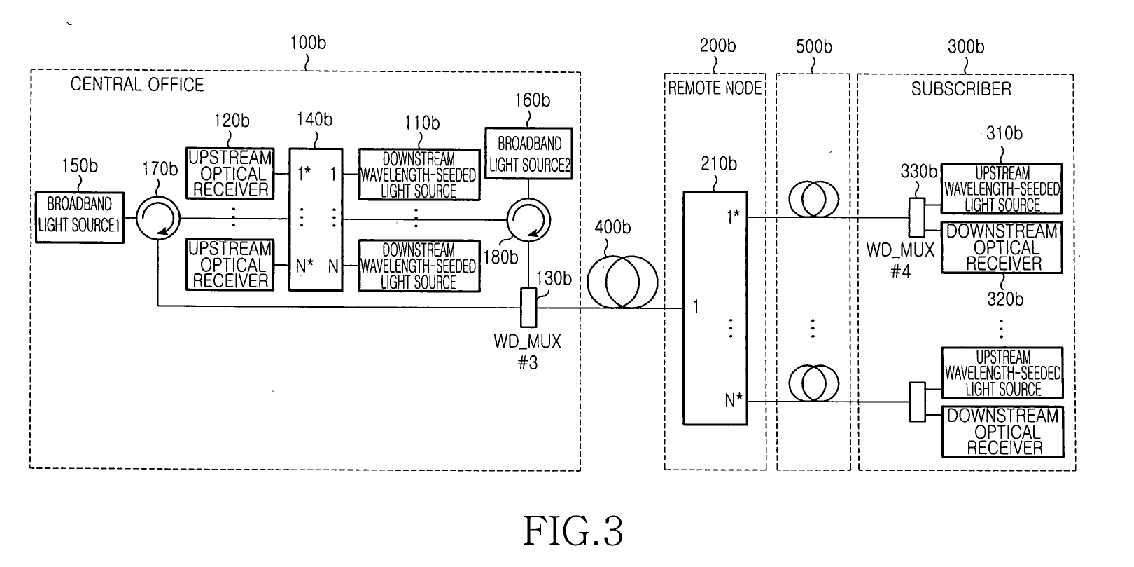

FIG. 3 shows a WDM-PON system according to the second embodiment of the present invention, and, in particular, illustrates an example of a central office 100b which includes two optical circulators 170b, 180b and one wavelength-division-multiplexer (WD_MUX #3) 130b, instead of the 2×2 optical splitter 170a and the N−1 wavelength-division-multiplexers (WD_MUX #1) 130a of the central office 100a of the first embodiment. The optical fiber 400b, remote nodes 200b, 500b and the plurality of subscriber units 300b are structurally and operationally similar to the optical fiber 400a, remote nodes 200a, 500a and the plurality of subscriber units 300a described in connection with FIG. 1.

The central office 100b includes two broadband light sources (first broadband light source 150b and second broadband light source 160b) for outputting optical signals with different wavelengths, N−1 downstream wavelength-seeded light sources 110b, N−1 upstream optical receivers (Rx) 120b, an N×N waveguide grating 140b for demultiplexing a multiplexed upstream signal and multiplexing downstream signals, first and second optical circulators 170b, 180b, and a wavelength-division-multiplexer (WD_MUX #3) 130b for multiplexing or demultiplexing a multiplexed downstream optical signal inputted from the first optical circulator 170b, a broadband signal inputted from the second optical circulator 180b and a multiplexed upstream optical signal transmitted from the remote node 200b. The first broadband light source 150b generates an optical signal which will be injected into the respective downstream wavelength-seeded light source 110b. The second broadband light source 160b generates an optical signal which will be injected into the respective upstream wavelength-seeded light source 310b of the plurality of subscriber units 300b.

In downstream operation, an optical signal generated by the first broadband light source 150b is inputted to the N×N waveguide grating 140b through the first optical circulator 170b. The optical signal is spectrum-sliced at the N×N waveguide grating 140b and then inputted to the respective downstream wavelength-seeded light sources 110b. Upon receiving the spectrum-sliced optical signal, the downstream wavelength-seeded light sources 110b outputs a downstream optical signal having the same wavelength as the received optical signal and directly modulated according to downstream data to be transmitted for input back to the N×N waveguide grating 140b. The N×N waveguide grating 140b multiplexes and outputs the inputted optical signal. The first optical circulator 170b transfers the multiplexed downstream signal to the wavelength-division-multiplexer (WD_MUX #3) 130b. Subsequently, the wavelength-division-multiplexer (WD_MUX #3) 130b transmits the downstream signal through the transfer optical fiber 400b to the remote node 200b.

In upstream operation, the second broadband light source 160b generates an optical signal. The second optical circulator 180b transfers the optical signal through the wavelength-division-multiplexer (WD_MUX #3) 130b to the remote node 200b. The wavelength-division-multiplexer (WD_MUX #3) 130b transfers back the received optical signal to the second optical circulator 180b which transfers the optical signal to the N×N waveguide grating 140b. The N×N waveguide grating 140b demultiplexes the multiplexed optical signal and transmits the demultiplexed signal to the respective upstream optical receivers 120b.

The remote node 200b includes an 1×waveguide grating 210b for demultiplexing a multiplexed downstream signal and multiplexing upstream signals. Each subscriber unit 300b includes a downstream optical receiver 320b, an upstream wavelength-seeded light source 310b and a wavelength-division-multiplexer (WD_MUX #2) 330b. Since the remote mode 200b and the subscriber units 300b are similar in structure and operation to the remote mode 200a and the subscriber units 300a illustrated in FIG. 1, detailed explanations thereof will be omitted.

In the WDM-PON system as shown in FIG. 3, a single wavelength-division-multiplexer 130b and the optical circulators 170b, 180b of the central office 100b can perform the same functions as the plurality of wavelength-division-multiplexers 130a and optical splitter 170a of the central office 100a. Accordingly, the WDM-PON system of FIG. 3 can be smaller than that of FIG. 1. Also, since in the WDM-PON system of FIG. 3, the optical circulators 170b, 180b and the wavelength-division-multiplexer (WD_MUX #3) 130b perform the same function as the 2×2 optical splitter 170a of the central office 100a shown in FIG. 1, the WDM-PON system of FIG. 3 can reduce losses of broadband signals generated by the first or second broadband light source 150b, 160b and injected into the downstream or upstream wavelength-seeded light source 110b, 310b, as well as optical signals outputted and transmitted from any wavelength-seeded light source.

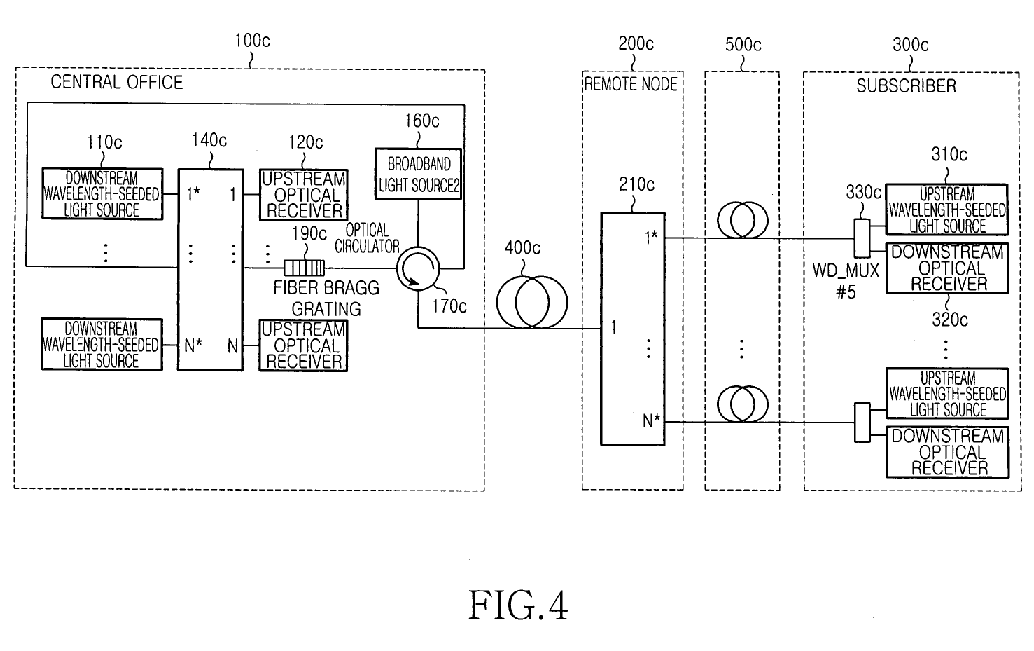

FIG. 4 shows a WDM-PON system according to the third embodiment of the present invention which differs from the second embodiment in that a fiber Bragg grating 190c is introduced to eliminate an optical circulator and a broadband light source in the central office but otherwise retains the structure and functionality of the first two embodiments with respect to remote nodes, subscriber units and the optical fiber to these downstream elements. The central office includes a single broadband light source capable of generating broadband signals having a wavelength greater than upstream or downstream signals, without using two broadband light sources for generating optical signals with different wavelengths.

The central office 100c includes N−1 downstream wavelength-seeded light sources 110c, N−1 upstream optical receivers 120c, an N×N waveguide grating 140c, a broadband light source 160c, an optical circulator 170c and a fiber Bragg grating 190c.

The broadband light source 160c simultaneously provides optical signals which will be injected into the downstream wavelength-seeded light source and the upstream wavelength-seeded light source. The fiber Bragg grating 190c makes use of the single light source 160c possible by passing a portion of the broadband signals generated by the broadband light source 160c having the wavelength of a downstream optical signal, while reflecting the portion having the wavelength of an upstream optical signal. In particular and in accordance with the operation of an optical circulator, the optical circulator 170c receives a broadband signal generated by the broadband light source 160c, a multiplexed downstream optical signal and a multiplexed upstream optical signal, and outputs the three signals to the fiber Bragg grating 190c, the transfer optical fiber 400c and the N×N waveguide grating 140c, respectively.

The N×N waveguide grating 140c receives a broadband signal component having the same wavelength as the downstream optical signal which passes through the fiber Bragg grating 190c. The N×N waveguide grating 140c spectrum slices the broadband signal and at the same time multiplexes and demultiplexes the upstream and downstream signals so that the upstream optical receivers 120c receive respective signals from the optical circulator 170c and so that signals back from the downstream wavelength-seeded light sources are transmitted to the fiber Bragg grating 190c.

In particular, the downstream wavelength-seeded light sources 110 receives the spectrum-sliced optical signal from the N×N waveguide grating 140c and each outputs a downstream optical signal having the same wavelength as the received optical signal and directly modulated according to downstream data to be transmitted.

The operation of the central office 100c will be explained below in detail.

In downstream operation, an optical signal generated by the broadband light source 160c is inputted to the fiber Bragg grating 190c through the optical circulator 170c. Of the inputted optical signal, only a portion having the wavelength of a downstream optical signal passes through the fiber Bragg grating 190c to be transmitted to the N×N waveguide grating 140c. The N×N waveguide grating 140c spectrum slices the received optical signal and outputs the spectrum-sliced signal to the downstream wavelength-seeded light source 110c. Upon receiving the spectrum-sliced optical signal, the downstream wavelength-seeded light source 110c outputs a downstream optical signal having the same wavelength as the received optical signal and directly modulated according to the downstream data to be transmitted, and inputs the downstream optical signal again to the N×N waveguide grating 140c. The N×N waveguide grating 140c multiplexes the inputted optical signal and outputs the multiplexed optical signal to the optical circulator 170c. The optical circulator 170c transmits the received downstream signal to the remote node 200c through the transfer optical fiber 400c.

In upstream operation, the broadband light source 160c generates an optical signal. The optical signal is transmitted to the fiber Bragg grating 190c through the optical circulator 170c. The fiber Bragg grating 190c has a property of passing downstream signals and reflecting upstream signals. The optical circulator 170c transmits an upstream signal reflected at the fiber Bragg grating 190c through the transfer optical fiber 400c to the remote node 200c. Also, the optical circulator 170c transmits an optical signal received from the remote node 200c to the N×N waveguide grating 140c. The N×N waveguide grating 140c demultiplexes the multiplexed optical signal and transmits the demultiplexed optical signal to the respective upstream optical receivers 120c.

The remote node 200c includes an 1×N waveguide grating 210c for demultiplexing a multiplexed downstream signal and multiplexing upstream signals. The subscriber units 300c include a downstream optical receiver 320c, an upstream wavelength-seeded light source 310c and a wavelength-division-multiplexer (WD_MUX #2) 330c. Since the remote mode 200c and the subscriber units 300c are similar in structure and operation to the remote mode 200a and the subscriber units 300a illustrated in FIG. 1, detailed explanations thereof will be omitted.

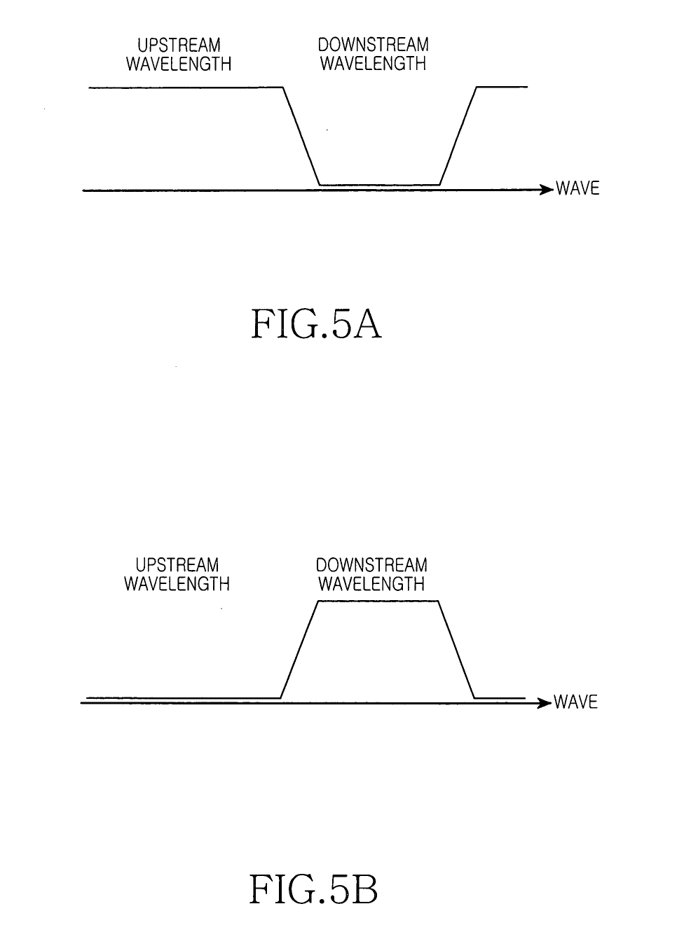

FIGS. 5a and 5b shows the signal passing characteristics of the broadband Bragg grating 190c provided in the WDM-PON system according to the third embodiment of the present invention. FIG. 5a shows the reflection of a broadband signal having a wavelength used for upstream transmission among broadband signals inputted to the broadband Bragg grating 190c. FIG. 5b shows the passing of a broadband signal having a wavelength used for downstream transmission among broadband signals inputted to the broadband Bragg grating 190c.

In the WDM-PON system according to any of the first to third embodiments of the present invention, the broadband light source should preferably be selected from an erbium-doped fiber amplifier, a semiconductor optical amplifier, a light-emitting diode and a superluminescent LED.

Also, the downstream wavelength-seeded light source should preferably be either a Fabry Perot laser or a reflective semiconductor optical amplifier.

Although preferred embodiments of the present invention have been described for illustrative purposes, those skilled in the art will appreciate that various modifications, additions and substitutions are possible, without departing from the scope and spirit of the invention as disclosed in the accompanying claims, including the full scope of equivalents thereof.

As described above, the present invention realizes an economical WDM-PON by directly modulating a wavelength-seeded light source to transmit upstream or downstream data, without using an expensive external modulator. Also, the present invention generates and uses a multiplexed signal having the same wavelength as the waveguide grating to control the temperature of the waveguide grating, thereby adjusting the wavelength of a wavelength-division-multiplexed signal routed to a transfer link. Therefore, the wavelength selectivity and stabilization of each light source are not required in the present invention. Since upstream and downstream signals can be multiplexed and demultiplexed concurrently by each waveguide grating located in the central office and the remote node, it is possible to reduce the number of waveguide gratings used in a WDM optical network. In addition, the present invention transmits upstream and downstream signals concurrently using a single-strand transfer optical fiber, thereby realizing an economical and efficient WDM-PON.

1. A wavelength division multiplexed passive optical network system including a central office and a remote node which is linked to the central office and a plurality of subscriber units through optical fibers, wherein said central office includes:
a first broadband light source for supplying an optical signal to be injected into a downstream wavelength-seeded light source;
a second broadband light source for supplying an optical signal to be injected into an upstream wavelength-seeded light source included in the plurality of subscriber units;
a 2×2 optical splitter for combining broadband signals generated by the first and second broadband light sources with upstream and downstream optical signals, respectively;
a 1×N mux/demux for spectrum-slicing a broadband signal generated by the first broadband light source and at the same time demultiplexing an upstream optical signal and/or multiplexing a downstream optical signal;
a wavelength-seeded light source for receiving a spectrum-sliced optical signal and outputting a downstream optical signal having the same wavelength as the received optical signal and directly modulated according to downstream data to be transmitted;
an optical receiver for detecting an upstream optical signal as an electric signal; and
a wavelength-division-multiplexer for demultiplexing the upstream optical signal and the spectrum-sliced optical signal and multiplexing the downstream optical signal.

2. The wavelength division multiplexed passive optical network system according to claim 1, wherein said 1×N mux/demux comprises a 1×N waveguide grating.

3. The wavelength division multiplexed passive optical network system according to claim 1, wherein said first broadband light source comprises an erbium-doped fiber amplifier.

4. The wavelength division multiplexed passive optical network system according to claim 1, wherein said first broadband light source comprises a semiconductor optical amplifier.

5. The wavelength division multiplexed passive optical network system according to claim 1, wherein said first broadband light source comprises a light-emitting diode.

6. The wavelength division multiplexed passive optical network system according to claim 1, wherein said first broadband light source comprises a superluminescent LED.

7. The wavelength division multiplexed passive optical network system according to claim 1, wherein said second broadband light source comprises an erbium-doped fiber amplifier.

8. The wavelength division multiplexed passive optical network system according to claim 1, wherein said second broadband light source comprises a semiconductor optical amplifier.

9. The wavelength division multiplexed passive optical network system according to claim 1, wherein said second broadband light source comprises a light-emitting diode.

10. The wavelength division multiplexed passive optical network system according to claim 1, wherein said second broadband light source comprises a superluminescent LED.

11. The wavelength division multiplexed passive optical network system according to claim 1, wherein said downstream wavelength-seeded light source comprises a Fabry-Perot laser.

12. The wavelength division multiplexed passive optical network system according to claim 1, wherein said downstream wavelength-seeded light source comprises a reflective semiconductor optical amplifier.

13. The wavelength division multiplexed passive optical network system according to claim 1, wherein said upstream and downstream signals have distinct wavelengths of 1,300 nm and 1,540 nm, or 1,540 nm and 1,300 nm, respectively.

14. The wavelength division multiplexed passive optical network system according to claim 1, wherein said upstream and downstream signals have distinct wavelengths of 1,300 nm and 1,580 nm, or 1,580 nm and 1,300 nm, respectively.

15. The wavelength division multiplexed passive optical network system according to claim 1, wherein said upstream and downstream signals have distinct wavelengths of 1,540 nm and 1,580 nm, or 1,580 nm and 1,540 nm, respectively.

16. The wavelength division multiplexed passive optical network system according to claim 1, wherein said remote node includes a 1×N mux/demux for spectrum-slicing a broadband signal generated and transmitted from the central office and at the same time demultiplexing a multiplexed downstream optical signal transmitted from the central office, while multiplexing an upstream optical signal transmitted from the subscriber units.

17. The wavelength division multiplexed passive optical network system according to claim 16, wherein said 1×N mux/demux comprises a waveguide grating.

18. The wavelength division multiplexed passive optical network system according to claim 1, wherein said subscriber units include:
a wavelength-division-multiplexer for demultiplexing the downstream optical signal and an optical signal spectrum-sliced at and transmitted from the remote node and for multiplexing the upstream optical signal;
an optical receiver for receiving the downstream optical signal; and
an upstream wavelength-seeded light source for receiving the optical signal spectrum-sliced at the remote node and outputting an upstream optical signal having the same wavelength as the received optical signal spectrum-sliced at the remote node and directly modulated according to upstream data to be transmitted.

19. A wavelength division multiplexed passive optical network system including a central office and a remote node which is linked to the central office and a plurality of subscriber units through optical fibers, wherein said central office includes:
a first broadband light source for supplying an optical signal to be injected into a downstream wavelength-seeded light source;
a second broadband light source for supplying an optical signal to be injected into an upstream wavelength-seeded light source included in the plurality of subscriber units;
an N×N mux/demux for spectrum-slicing a broadband signal generated by the first broadband light source and at the same time demultiplexing a multiplexed upstream optical signal from the remote node and/or multiplexing a downstream optical signal;
a first optical circulator for inputting a broadband signal generated by the first broadband light source to the N×N mux/demux and a multiplexed downstream optical signal outputted from the N×N mux/demux to a transfer optical fiber;
a second optical circulator for inputting a broadband signal generated by the second broadband light source to the transfer optical fiber and a multiplexed upstream optical signal transmitted to the N×N mux/demux for said demultiplexing;
a wavelength-division-multiplexer for demultiplexing the multiplexed downstream optical signal inputted from the first optical circulator, the broadband signal inputted from the second optical circulator and said multiplexed upstream optical signal;
a wavelength-seeded light source for receiving the spectrum-sliced optical signal and outputting a downstream optical signal having the same wavelength as the received optical signal and directly modulated according to downstream data to be transmitted; and
an optical receiver for detecting an upstream optical signal as an electric signal.

20. The wavelength division multiplexed passive optical network system according to claim 19, wherein said remote node includes an 1×N mux/demux for spectrum-slicing a broadband signal generated and transmitted from the central office and at the same time demultiplexing a multiplexed downstream optical signal transmitted from the central office, while multiplexing an upstream optical signal transmitted from the subscriber units.

21. The wavelength division multiplexed passive optical network system according to claim 19, wherein said subscriber units include:
a wavelength-division-multiplexer for demultiplexing the downstream optical signal and an optical signal spectrum-sliced at and transmitted from the remote node and multiplexing the upstream optical signal;
an optical receiver for receiving the downstream optical signal; and
an upstream wavelength-seeded light source for receiving the optical signal spectrum-sliced at the remote node and outputting an upstream optical signal having the same wavelength as the received optical signal spectrum-sliced at the remote node and directly modulated according to upstream data to be transmitted.

22. A wavelength division multiplexed passive optical network system including a central office and a remote node which is linked to the central office and a plurality of subscriber units through optical fibers, wherein said central office includes:
a broadband light source for simultaneously supplying optical signals to be injected into a downstream wavelength-seeded light source and an upstream wavelength-seeded light source;
a fiber Bragg grating for passing a portion of broadband optical signals generated by the broadband light source, said portion having a wavelength of a downstream optical signal, while said grating reflects a portion having a wavelength of an upstream optical signal;
an optical circulator for outputting the broadband signals generated by the broadband light source to the fiber Bragg grating, said multiplexed downstream optical signal to a transfer optical fiber and said multiplexed upstream optical signal to an N×N mux/demux;
said N×N mux/demux for receiving and spectrum-slicing a broadband signal having the same wavelength as the downstream optical signal passing through the fiber Bragg grating and at the same time multiplexing a downstream optical signal and/or demultiplexing an upstream optical signal;
a wavelength-seeded light source for receiving the spectrum-sliced optical signal and outputting the downstream optical signal to be multiplexed, said downstream optical signal to be multiplexed having the same wavelength as the received optical signal and being directly modulated according to downstream data to be transmitted; and
an optical receiver for detecting an upstream optical signal as an electric signal.

23. The wavelength division multiplexed passive optical network system according to claim 22, wherein said remote node includes an 1×N mux/demux for receiving a broadband signal having the same wavelength as the upstream optical signal reflected by and transmitted from the fiber Bragg grating and spectrum-slicing the received broadband signal and at the same time demultiplexing a multiplexed downstream optical signal transmitted from the central office, while multiplexing an upstream optical signal transmitted from the subscriber units.

24. The wavelength division multiplexed passive optical network system according to claim 22, wherein said subscriber units include:
a wavelength-division-multiplexer for demultiplexing a downstream optical signal and for demultiplexing and multiplexing a spectrum-sliced optical signal transmitted from the remote node and an upstream optical signal;
an optical receiver for receiving a downstream optical signal; and
an upstream wavelength-seeded light source for receiving the spectrum-sliced optical signal and outputting an upstream optical signal having the same wavelength as the received spectrum-sliced optical signal and directly modulated according to upstream data to be transmitted.
